(19) United States
(12) Patent Application Publication
(10) Pub. No.: US 2006/0284405 A1
(43) Pub. Date: Dec. 21, 2006

(54) Trailer landing gear sand shoe apparatus

(76) Inventor: Bobby G. Baxter, Warrenton, MO (US)

Correspondence Address: THOMPSON COBURN, LLP, ONE US BANK PLAZA, SUITE 3500, ST LOUIS, MO, 63101, US

(21) Appl. No.: 11/154,240

(22) Filed: Jun. 16, 2005

(51) Int. Cl. B60S 9/02

(52) U.S. Cl. 280/763.1

(57) ABSTRACT

A trailer landing gear sand shoe is provided with three surface areas that support the landing gear and trailer and avoid damaging the ground surface supporting the sand shoe should the trailer shift forwardly or rearwardly. The novel construction of the landing gear sand shoe has forward and rearward peripheral rims that reinforce the three surface areas.

### BACKGROUND OF THE INVENTION

(1) Field of the Invention

The present invention pertains to a trailer landing gear sand shoe of novel construction. In particular, the landing gear sand shoe of the present invention is provided with three surface areas that support the landing gear and trailer, and avoid damaging the surface supporting the sand shoe should the trailer shift forwardly or rearwardly. In addition, the present invention pertains to the novel construction of a landing gear sand shoe that has three separate supporting surfaces for supporting a trailer landing gear, and also has forward and rearward peripheral rims that reinforce the three surface areas.

(2) Description of the Related Art

Many of the different types of trailers that are towed by trucks are connected to the trucks by a releasable coupling at the forward end of the trailer. When the trailer is released from the truck and is no longer supported by the truck at the trailer forward end, a landing gear assembly is often used to support the trailer forward end.

The typical landing gear assembly is attached to the underside of the trailer at a position adjacent the forward end of the trailer. The assembly includes a pair of vertically oriented columns positioned adjacent opposite sides of the trailer. A vertical leg is mounted in each column. A gear mechanism on each column is selectively operated to lower the legs from the columns, or raise the legs in the columns. The gear mechanism is typically manually operated by rotating a hand crank connected to the gear mechanism.

Support surfaces are provided at the bottom ends of the landing gear assembly legs for engaging with the ground surface supporting the trailer. A device commonly known as a sand shoe typically provides the support surface at the bottom of the landing gear assembly legs. A sand shoe is basically a flat plate that is attached either directly or indirectly to the bottom of each landing gear assembly leg to function as a ground surface contact support for the trailer. The sand shoe provides an increased bearing surface area that engages with the ground surface in supporting the trailer. The primary function of the sand shoe is to prevent the landing gear assembly legs from sinking into soft ground.

The prior art sand shoe has been found to be disadvantaged in that when the trailer is supported by the landing gear assembly and the sand shoes and the trailer moves forwardly or rearwardly, for example during loading, the sand shoes have a tendency to rock over the ground surface. This can cause forward and/or rearward portions of the sand shoe to bend due to the concentration of forces in these areas of the sand shoe when the trailer is moved forwardly or rearwardly. In addition, the forward and rearward movement of the trailer can cause the sand shoe to move up onto a forward or rearward edge of the sand shoe, resulting in the forward or rearward edge of the sand shoe digging deep into the ground surface. This can cause the trailer forward end to move downwardly away from the desired horizontal orientation of the trailer when loading, and can cause damage to the ground surface supporting the trailer landing gear, for example scratching or cracking of a concrete or asphalt surface.

What is needed to overcome the disadvantages associated with prior art sand shoes is an improved sand shoe construction that allows for forward and rearward rocking of the trailer and landing gear assembly on the sand shoe without causing damage to the sand shoe, and without causing damage to the ground surface supporting the sand shoe, and where the construction of the improved sand shoe is not significantly more expensive than that of prior art sand shoes.

### SUMMARY OF THE INVENTION

The trailer landing gear assembly of the present invention employs a sand shoe of novel construction that supports the landing gear and trailer when the trailer shifts forwardly or rearwardly, and also provides three different shoe plate areas that support the landing gear and trailer when the landing gear is positioned upright relative to a supporting surface, when the landing gear and trailer are shifted forwardly from the upright position of the landing gear, and when the landing gear and trailer are shifted rearwardly from the upright position of the landing gear.

The landing gear assembly sand shoe is basically comprised of a base plate, a front plate, a rear plate, and a peripheral rim that extends around the base plate, front plate, and rear plate. All of the plates and the rim of the invention are constructed of metal, preferably 5/16 inch metal sheet. The component parts of the inventive sand shoe can be welded together to form the unitary sand shoe, or can be stamped from a single sheet of metal to form the unitary sand shoe. The sand shoe of the invention can be connected to a leg of a landing gear assembly according to any known method of connection, or later developed equivalent method of connection.

The base plate has a generally rectangular configuration with a longitudinal length and lateral width. The length of the base plate is defined by longitudinally spaced and parallel forward and rearward edges of the base plate. The top surface of the base plate has a center area that is adapted to be connected to a landing gear leg. The bottom surface of the base plate is designed as the primary supporting surface of the inventive sand shoe and landing gear assembly.

The front plate is connected to the base plate along the forward edge of the base plate. The front plate has a straight base plate edge that connects to the base plate, and has an opposite, curved forward edge. The base edge and the forward edge of the front plate give the front plate a general semi-circular configuration. The front plate is generally flat, and angles upwardly relative to the base plate from the base plate forward edge.

The rear plate basically has the same configuration as the front plate. The rear plate has a base edge that is connected to the base plate along the base plate rearward edge. The rear plate has an opposite, curved rearward edge that, together with the base plate edge, gives the rear plate a general semi-circular configuration. The rear plate also angles upwardly from its connection to the base plate along the base plate rearward edge.

A front rim is connected to the front plate curved edge and to portions of the opposite side edges of the base plate. The front rim has a general crescent shape that extends around the front plate and across portions of the opposite side edges of the base plate. The arcuate front rim has a variable width. The front rim has its greatest width at an intermediate portion of the rim, positioned forwardly of the front plate curved edge. From the intermediate portion of the rim, the rim extends in opposite directions around the curved edge of the front plate and then across portions of the opposite side edges of the base plate to the opposite terminal ends of the front rim. As the front rim extends from its intermediate portion to its opposite terminal ends, the width of the front rim gradually decreases. This gives the front rim its crescent shape.

A rear rim is constructed having the basic configuration of the front rim. The rear rim is positioned rearwardly of the rear plate curved edge, and curves around the rear plate curved edge to portions of the opposite side edges of the base plate. The rear rim has its greatest width at an intermediate portion of the rim adjacent the rear plate curved edge, and the rim width tapers as it extends around the rear plate curved edge to opposite terminal ends of the rim at the opposite side edge portions of the base plate.

The bottom surface of the base plate provides the primary support surface for the trailer landing gear assembly. With the landing gear assembly lowered from the trailer and the landing gear assembly legs positioned uprightly or vertically, the bottom surface of the base plate engages the ground surface to support the trailer and provides a sufficient surface area to support the trailer without significantly sinking into the ground surface or otherwise deforming the ground surface.

Should the trailer rock forwardly or rearwardly on loading or unloading of the trailer, or for other reasons, the respective front plate and rear plate would be moved beneath the forwardly oriented or rearwardly oriented landing gear assembly legs. The front plate or rear plate would then provide sufficient surface area to support the trailer on the ground surface without appreciably sinking into the ground surface or otherwise deforming the ground surface.

The front rim and rear rim extend around the periphery of the sand shoe and reinforce the base plate and front and rear plates against bending. The front and rear rims are angled relative to the base plate and the front and rear plates, and thereby function as a reinforcing web for the base plate, front plate, and rear plate. In addition, as the opposite ends of the front and rear rims extend around the respective front plate and rear plate and over portions of the opposite side edges of the base plate, the front and rear rims taper to their narrowest widths at the opposite terminal ends of the front and rear rims. This forms a pair of drain troughs between the terminal ends of the front rim and rear rim at the centers of the side edges of the base plate. The troughs allows any rain water collected on the sand shoe to drain away from the top surface of the base plate through the troughs.

The sand shoe of the invention described above has a novel configuration that provides a supporting surface to a trailer landing gear assembly when the landing gear legs are positioned uprightly, are shifted or oriented forwardly, or are shifted or oriented rearwardly. In addition, the novel sand shoe configuration provides a reinforcing rim around the periphery of the sand shoe that does not allow rain water to collect on the top surface of the sand shoe.

### BRIEF DESCRIPTION OF THE DRAWINGS

Further features of the present invention are set forth in the following detailed description of the preferred embodiment of the invention and in the drawing figures wherein:

FIG. 1 is a front perspective view of the landing gear leg of the invention employing the novel configuration of the sand shoe of the invention;

FIG. 2 is a top plan view of the leg and sand shoe of FIG. 1;

FIG. 3 is a perspective view of the sand shoe of the invention employing a different means for connecting the sand shoe to a landing gear assembly leg;

FIG. 4 is a top plan view of the sand shoe of FIG. 3;

FIG. 5 is a front elevation view of the sand shoe of FIG. 3; and

FIG. 6 is a side elevation view of the sand shoe of FIG. 3.

### DETAILED DESCRIPTION OF THE PREFERRED EMBODIMENT

The trailer landing gear sand shoe apparatus of the present invention employs a novel sand shoe construction that supports a landing gear and trailer on a ground surface when the trailer shifts forwardly and rearwardly, and prevents damage to the sand shoe or to the ground surface due to the shifting movement of the trailer. The sand shoe of the invention provides three different ground surface supporting areas that support the landing gear and trailer when the landing gear is positioned upright relative to the supporting ground surface, when the landing gear and trailer are shifted forwardly from the upright position of the landing gear, and when the landing gear and trailer are shifted rearwardly from the upright position of the landing gear.

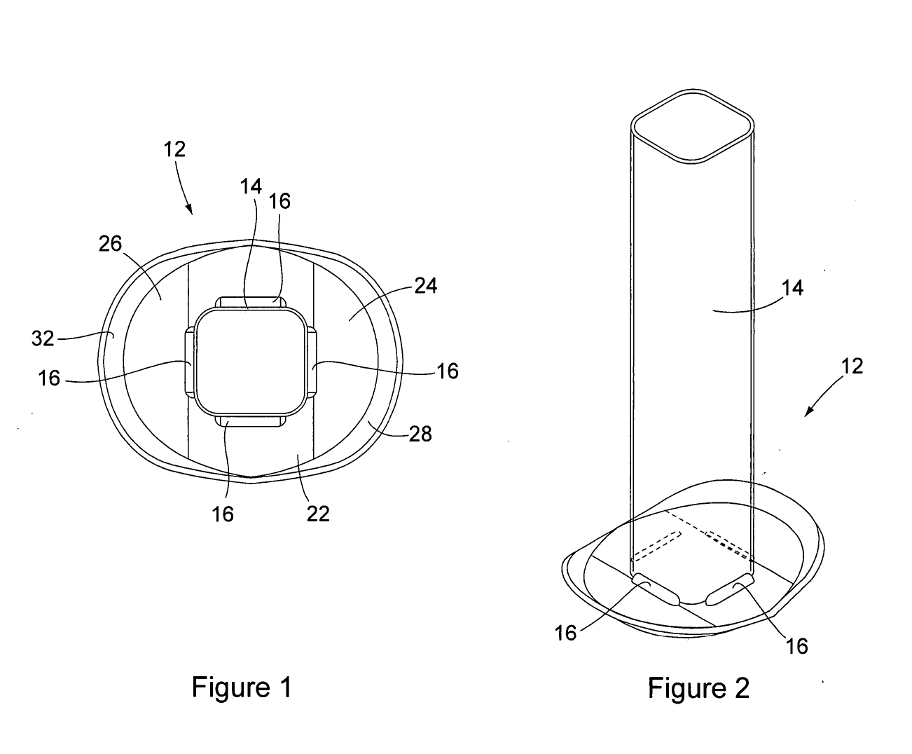

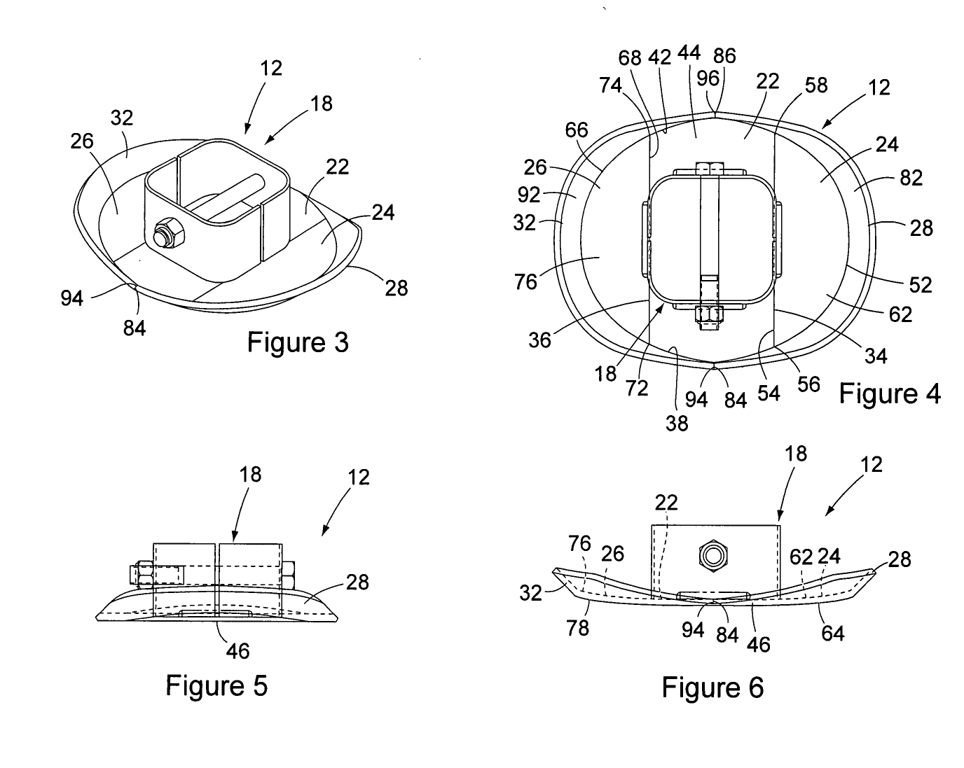

The trailer landing gear sand shoe apparatus of the invention is shown in FIG. 1. Basically, the apparatus is comprised of a novel sand shoe construction that can be connected to the bottom end of a landing gear leg of various different constructions of landing gear assemblies. The sand shoe 12 of the invention is shown connected to the landing gear leg 14 by weld connection 16 in FIG. 1. It should be understood that this connection is only one example of the many different equivalent types of connections employed between landing gear legs and sand shoes. The trailer landing gear sand shoe apparatus of the invention is not intended to be limited to weld connections to landing gear assembly legs. This is illustrated in FIGS. 3-6 which show the sand shoe 12 of the invention connected to a pivot connection assembly 18 employed to removably attach the sand shoe to a landing gear assembly leg.

The landing gear assembly sand shoe 12 is basically comprised of a base plate 22, a front plate 24, a rear plate 26, and a peripheral rim 28, 32 that extends around the base plate, front plate, and rear plate. All of the plates and the rim of the invention are constructed of metal, preferably 5/16 inch metal sheet. The component parts of the sand shoe can be welded together to form the unitary shoe, or can be stamped from a single sheet of metal to form the unitary shoe. As stated earlier, the sand shoe of the invention can be connected to a leg of a landing gear assembly according to any known method of connection, or later developed equivalent method of connection.

Referring to FIG. 4, the base plate has a generally rectangular configuration defined by the longitudinally spaced forward edge 34 and rearward edge 36 of the base plate, and the laterally spaced side edges 38, 42 of the base plate. The forward 34 and rearward 36 edges of the base plate are parallel to each other. The base plate has a flat top surface 44 and a flat bottom surface 46, and has a uniform thickness between these two surfaces. As shown in the drawing figures, the base plate top surface 44 has a central area that is adapted to be connected to a landing gear assembly leg, either directly by welds 16 such as those shown on FIGS. 1 and 2, or indirectly by a pivot connection assembly 18 such as that shown in FIGS. 3-6. The bottom surface 46 of the base plate 22 is designed as the primary supporting surface of the sand shoe 12 and the landing gear assembly leg 14. The bottom surface 46 is designed to engage flat on the ground surface supporting the landing gear assembly and the trailer when the landing gear assembly leg 14 is oriented uprightly.

The front plate 24 has a general semi-circle configuration defined by a curved edge 52 of the front plate and a longitudinally opposite, straight base plate edge 54 of the front plate. The base plate edge 54 of the front plate 24 is connected to the forward edge 34 of the base plate 22. The curvature of the front plate curved edge 52 causes the opposite ends 56, 58 of the curved edge to intersect with the straight base plate edge 54 of the front plate. The front plate top surface 62 and bottom surface 64 curve slightly upwardly relative to the base plate 22, as can be seen in FIG. 6. The front plate 24 has a constant thickness between it's top 62 and bottom 64 surfaces.

The front plate bottom surface 64 is designed to provide a sufficient surface area forward of the base plate 22 to support the landing gear assembly and trailer on the ground surface should the trailer move forwardly and the sand shoe 12 rock forwardly onto the front plate 22.

The rear plate 26 has the same basic construction as the front plate 24. The rear plate 26 has the semi-circle configuration defined by a curved edge 66 and a straight base plate edge 68 of the rear plate. The straight base plate edge 68 is connected to the base plate rearward edge 36. The rear plate curved edge 66 has opposite ends 72, 74 that intersect the straight base plate edge 68. The rear plate also has opposite top 76 and bottom 78 surfaces that angle slightly upwardly relative to the base plate 22, as seen in FIG. 6.

Like the front plate 22, the rear plate 26 is designed to provide a sufficient surface area rearwardly of the base plate 22 to support the landing gear assembly on the ground surface should the trailer move rearwardly and the sand shoe 12 rock rearwardly onto the rear plate bottom surface 78.

As shown in FIG. 6, the upward angling of the front plate 24 and the rear plate 26 relative to the base plate 22 gives the bottom surface areas of the three plates a substantially uniform radius between the forward most portion of the front plate curved edge 52 and the rearward most portion of the rear plate curved edge 66. With the sand shoe 12 resting on a flat horizontal surface, the minimal rise of the front plate 24 and rear plate 26 relative to the base plate 22 will space the forward most portion of the front plate curved edge 52 and the rearward most portion of the rear plate curved edge 66 approximately ⅜ of an inch above the horizontal surface supporting the sand shoe 12.

The sand shoe 12 peripheral rim is comprised of a front rim 28 and a rear rim 32. As seen in FIG. 4, the two rims 28, 32 extend completely around the periphery of the base plate 22, the front plate 24, and the rear plate 26, and reinforce these plates against bending.

The front rim 28 has an arcuate, crescent configuration that extends around and is connected to the front plate curved edge 52 and portions of the base plate side edges 38, 42. The front rim 28 has a variable width, and has its greatest width at an intermediate portion 82 of the front rim that is connected to the forward most portion of the front plate curved edge 52. From the rim intermediate portion 82, the rim extends in opposite directions around the front plate 24 toward terminal ends 84, 86 of the rim that are connected to the base plate side edges 38, 42. As the rim extends from the intermediate portion 82 to the terminal ends 84, 86, the width of the rim tapers and narrows, giving the front rim 28 its crescent shape.

As shown in FIG. 6, the front rim 28 angles upwardly relatively to the base plate 22 and the front plate 24 as it projects longitudinally outwardly from the base plate 22 and front plate 24. This angled orientation of the front rim 28 reinforces the base plate 22 and front plate 24 against bending. As the front rim 28 extends from its intermediate portion 82 around to its opposite terminal ends 84, 86, the rim narrows to the extent that the opposite terminal ends 84, 86 of the rim are positioned in basically the same plane as the base plate 22.

The construction of the rear rim 32 is basically the same as that of the front rim 28. The rear rim 32 also has an arcuate, crescent configuration that extends around and is connected to the rear plate curved edge 66 and portions of the base plate side edges 38, 42. The crescent configuration of the rear rim 32 has a variable width, with an intermediate portion 92 of the rim having its greatest width positioned rearwardly of the rear plate curved edge 66. From the intermediate portion 92, the rear rim 32 extends around the rear plate 26 to opposite terminal ends 94, 96 of the rim. The rear rim width narrows as it extends from the intermediate portion 92 to the opposite terminal ends 94, 96, with the opposite terminal ends 94, 96 being positioned in basically the same plane as the base plate 22.

The opposed front rim terminal ends 84, 86 and rear rim terminal ends 94, 96 form V-shaped troughs at the middles of the base plate side edges 38, 42. These troughs allow for the drainage of any rainwater or other water that collects on the top surfaces of the base plate 22 and front and rear plates 24, 26 within the rims 28, 32.

As stated earlier, the base plate bottom surface 46 provides the primary support surface for the landing gear leg 14 and the trailer landing gear assembly. With the landing gear assembly lowered from the trailer and the leg 14 positioned uprightly or vertically, the base plate bottom surface 46 engages the supporting ground surface and provides a sufficient surface area to support the trailer without significantly sinking into the supporting ground surface or otherwise deforming the supporting ground surface.

Should the trailer rock forwardly or rearwardly on loading or unloading of the trailer, or for other reasons, the respective front plate 24 and rear plate 26 would be moved beneath the forwardly oriented or rearwardly oriented landing gear leg 14. The front plate 24 or rear plate 26 would then provide sufficient surface area to support the trailer on the supporting ground surface without appreciably sinking into the supporting ground surface or otherwise deforming the supporting ground surface.

The front rim 28 and rear rim 32 extending around the periphery of the sand shoe 12 and reinforce the base plate 22, the front plate 24, and the rear plate 26 against bending. The front 28 and rear 32 rims are angled relative to the base plate 22, front plate 24, and rear plate 26, and thereby function as a reinforcing web for the plates. In addition, as the front rim 28 extends around the front plate 22 and base plate 22 to its terminal ends 84, 86, and the rear rim 32 extends around the rear plate 26 and the base plate 22 to its terminal ends 94, 96, the front and rear rims taper to their narrowest widths at their opposed terminal ends. This forms drain troughs between the front plate terminal ends 84, 86 and the rear plate terminal ends 94, 96 at the centers of the base plate side edges 38, 42. The troughs allow any rainwater collected on the sand shoe to drain away from the top surface of the base plate 22 through the troughs.

The sand shoe of the invention described above has a novel configuration that provides a supporting surface to a trailer landing gear assembly when the landing gear legs are positioned uprightly, or are shifted or oriented forwardly, or are shifted or oriented rearwardly. In addition, the novel sand shoe configuration provides a reinforcing rim around the periphery of the sand shoe that does not allow rainwater to collect on the top surface of the sand shoe.

Although the apparatus of the apparatus of the invention has been described above by reference to a specific embodiment of the invention, it should be understood that modifications and variations of the invention could be arrived at without departing from the intended scope of protection provided by the following claims.

1) A trailer landing gear sand shoe apparatus comprising:
a base plate having opposite top and bottom surfaces, longitudinally spaced forward and rearward edges, and laterally spaced side edges, the base plate top surface being adapted for connection to a leg of a trailer landing gear assembly;
a front plate having opposite top and bottom surfaces, a base plate edge connected to the base plate forward edge, and a curved edge longitudinally opposite the base plate edge, the front plate angling upwardly above the base plate top surface as the front plate extends from the base plate edge to the curved edge; and,
a rear plate having opposite top and bottom surfaces, a base plate edge connected to the base plate rearward edge, and a curved edge longitudinally opposite the base plate edge, the rear plate angling upwardly above the base plate top surface as the rear plate extends from the rear plate base plate edge to the rear plate curved edge.

2) The apparatus of claim 1, further comprising:
the base plate forward edge and rearward edge being parallel.

3) The apparatus of claim 2, further comprising:
the front plate curved edge having opposite terminal ends that intersect the front plate base plate edge; and,
the rear plate curved edge having opposite terminal ends that intersect the rear plate base plate edge.

4) The apparatus of claim 1, further comprising:
a front rim connected to the front plate curved edge with the front rim angling upwardly from the front plate top surface; and,
a rear rim connected to the rear plate curved edge with the rear rim angling upwardly from the rear plate top surface.

5) The apparatus of claim 4, further comprising:
the front rim having an arcuate shape with an intermediate portion of the front rim being connected to the front plate curved edge and opposite end portions of the front rim being connected to portions of the laterally spaced side edges of the base plate; and,
the rear rim having an arcuate shape with an intermediate portion of the rear rim being connected to the rear plate curved edge and opposite end portions of the rear rim being connected to portions of the laterally spaced side edges of the base plate.

6) The apparatus of claim 5, further comprising:
the front rim opposite end portions opposing the rear rim opposite end portions at the side edges of the base plate.

7) The apparatus of claim 5, further comprising:
the front rim having a width that tapers as the front rim extends from the front rim intermediate portion to the front rim end portions; and,
the rear rim having a width that tapers as the rear rim extends from the rear rim intermediate portion to the rear rim end portions.

8) The apparatus of claim 1, further comprising:
a landing gear assembly leg connected to the base plate.

9) A trailer landing gear sand shoe apparatus comprising:
a base plate having opposite top and bottom surface, longitudinally spaced forward and rearward edges, and laterally spaced side edges, the base plate top surface being adapted for connection to a leg of a landing gear assembly;
an arcuate front rim connected to the base plate adjacent the base plate forward edge, the front rim having a crescent shape with an intermediate portion and opposite terminal ends, the front rim having a width that is widest at the front rim intermediate portion and narrows as the front rim extends from the front rim intermediate portion to the front rim opposite terminal ends; and,
an arcuate rear rim connected to the base plate adjacent the base plate rearward edge, the rear rim having a crescent shape with an intermediate portion and opposite terminal ends, the rear rim having a width that is widest at the rear rim intermediate portion and narrows as the rear rim extends from the rear rim intermediate portion to the rear rim opposite terminal ends.

10) The apparatus of claim 9, further comprising:
the front rim opposite terminal ends being connected to the base side edges; and,
the rear rim opposite terminal ends being connected to the base side edges.

11) The apparatus of claim 10, further comprising:
the front rim opposite terminal ends opposing the rear rim opposite terminal ends and forming drain troughs therebetween.

12) The apparatus of claim 10, further comprising:
the front rim intermediate portion being spaced longitudinally from the base plate forward edge; and,
the rear rim intermediate portion being spaced longitudinally from the base plate rearward edge.

13) The apparatus of claim 10, further comprising:
the base plate forward edge and rearward edge being parallel.

14) The apparatus of claim 9, further comprising:
the front rim and the rear rim angling upwardly above the base plate top surface.

15) The apparatus of claim 9, further comprising:
a landing gear assembly leg connected to the base plate.

16) A trailer landing gear sand shoe apparatus comprising:
a base plate having opposite top and bottom surfaces, longitudinally spaced forward and rearward edges, and laterally spaced side edges, the base plate top surface being adapted for connection to a leg of a trailer landing gear assembly;
a front plate having a semi-circular configuration with opposite top and bottom surfaces, the front plate being connected to the base plate forward edge with the front plate angling upwardly above the base plate top surface as the front plate extends longitudinally outwardly from the base plate;
a rear plate having a semi-circular configuration with opposite top and bottom surfaces, the rear plate being connected to the base plate rearward edge with the rear plate angling upwardly above the base plate top surface as the rear plate extends longitudinally outwardly from the base plate;
a front rim having a crescent shape, the front rim having an intermediate portion connected to the front plate and the front rim having opposite end portions connected to the base plate side edges; and,
a rear rim having a crescent shape, the rear rim having an intermediate portion connected to the rear plate and the rear rim having opposite end portions connected to the base plate side edges.

17) The apparatus of claim 16, further comprising:
the base plate and front rim being on longitudinally opposite sides of the front plate; and,
the base plate and the rear rim being on longitudinally opposite sides of the rear plate.

18) The apparatus of claim 16, further comprising:
the front rim opposite end portions opposing the rear rim opposite end portions at the side edges of the base plate.

19) The apparatus of claim 16, further comprising:
the front rim having a width that tapers as the front rim extends from the front rim intermediate portion to the front rim end portions; and,
the rear rim having a width that tapers as the rear rim extends from the rear rim intermediate portion to the rear rim end portions.

20) The apparatus of claim 16, further comprising:
the front rim opposite end portions opposing the rear rim opposite end portions and forming drain troughs therebetween at the base plate side edges.

21) The apparatus of claim 16, further comprising:
the base plate forward edge and rearward edge being parallel.

22) The apparatus of claim 16, further comprising:
the front rim angling upwardly from the front plate and the rear rim angling upwardly from the rear plate.

23) The apparatus of claim 16, further comprising:
a landing gear assembly leg connected to the base plate top surface.
